(19) United States
(12) Patent Application Publication
(10) Pub. No.: US 2009/0165500 A1
(43) Pub. Date: Jul. 2, 2009

(54) Method and Device for Bubble-free Transportation, Homogenization and Conditioning of Molten Glass

(75) Inventors: Katharina Luebbers, Mainz-Kastel (DE); Johannes Stinner, Mainz (DE); Paul Kissl, Mainz (DE); Erhard Dick, Pechbrunn (DE); Roland Fuchs, Leonberg (DE); Joerg Witte, Pfungstadt (DE)

Correspondence Address: DeMont & Breyer, LLC, 100 Commons Way, Ste. 250, Holmdel, NJ, 07733, US

(73) Assignee: SCHOTT AG, 55122 Mainz (DE)

(21) Appl. No.: 12/161,903

(22) PCT Filed: Jan. 18, 2007
(86) PCT No.: PCT/EP2007/000407

§ 371 Date: Nov. 4, 2008

(30) Foreign Application Priority Data
Jan. 24, 2006 (DE) 10 2006 003 531.3

(51) Int. Cl. C03B 35/00; C03B 19/00

(52) U.S. Cl. 65/32.5; 65/157

(57) ABSTRACT

The present invention relates to a device and method for transporting, homogenizing or conditioning of glass melts or glass ceramic melts and is distinguished in that the new formation of bubbles after refining is at least reduced. The new formation of bubbles on the surfaces of components that are in contact with the melt is at least reduced by means of a layer having iridium as a material.

### DESCRIPTION OF THE INVENTION

The present invention relates to a device and a method for transporting, homogenizing and conditioning of glass melts or glass ceramic melts.

### PRIOR ART

For the quality of a glass, particularly an optical glass, the absence of gas inclusions or gas bubbles and discolorations is crucial to the distortion-free transmission of electromagnetic radiation. The quality of a glass is further determined substantially by its homogeneity and the absence of streaks. Toxic substances in the glass, or at least those that are questionable in terms of the environment or health, such as arsenic or antimony, should be reduced or avoided as far as possible.

In the field of production and manufacturing, particularly in the glass industry, tubs, crucibles, containers, transportation means and tools made of noble metals from the platinum group, alloys thereof as well as fused silica or refractory ceramics are used for handling melts.

An example of this is a feeder channel, which is needed in general for the transportation of the glass melt from a melting device or a refining device to a processing unit, as well as for conditioning, i.e., when the melting and refining process is finished and the glass must be brought to the desired shaping temperature.

Currently, iridium or iridium alloys are used for components for producing glass, for example, if no contaminants are to reach the glass due to corrosion of the components (DE 1906717), or if there is a need for the outstanding mechanical and thermomechanical properties of iridium or iridium-based alloys at high temperatures, particularly greater than 1600° C., in a glass melting furnace for example (JP 02-022132).

The first process step in glass production is the melting of the precursor substances in a melting crucible. There must be thorough intermixing and degassing of the glass melt in order to achieve a maximum homogeneity and freedom from bubbles. Therefore, the melting is generally followed by the refining and homogenization of the glass melt. The essential goal of the refining is to remove from the melt the gases that are physically and chemically bound to it.

After refining, the glass melt is ideally bubble-free. During the transport of the glass melt to an additional processing step, a new inclusion of bubbles in the glass, or a new formation of bubbles, should be avoided in order to avoid undesired quality impairment of the glass.

It is known that the use of quartz or ceramics as the wall material or as the melt contact material of a transport device can lead to the formation of bubbles and/or streaks in the glass melt and ultimately in the glass end product. The streaks generally originate in inhomogeneities of the glass with deviating optical values. The creation of streaks can be avoided, however, by using metals such as platinum or platinum alloys for constructing, or at least lining, the components in contact with the melt.

Platinum is expensive, however. Components made of platinum or platinum alloys also have the disadvantage that, due to the corrosiveness of the glass melt, small amounts of platinum or other alloy constituents may be introduced into the melt, which are then present both in ionic form and in fine dispersions in the glass end product. Depending on the concentration and the particle size in the glass end product, the introduction of elemental or ionic platinum into the melt leads to an undesired coloration and a reduced transmission in the visible range of electromagnetic radiation.

It is additionally known that formation of bubbles, oxygen bubbles in particular, occurs at the contact surface of the platinum with the melt. After the actual refining of the glass, there is thus a new formation of bubbles and accordingly an undesired new inclusion of bubbles into the already refined glass melt.

A possible explanation for the new formation of bubbles in the glass melt, more precisely, at the interface between the glass melt and the platinum wall, is based on the following approach. At the temperatures prevailing in a glass melt, there is a dissociation of water into its components, hydrogen and water, which are accordingly present in atomic or molecular form in the melt. In the center of the glass melt, there is an equilibrium between the dissociation of the water into its components and the reverse reaction. In the contact area of the melt with the wall consisting of platinum, on the other hand, the hydrogen is capable of diffusing through the platinum to the side of the wall facing away from the melt, while the oxygen remains behind in the melt. If the hydrogen content on the outside of a platinum component is less than on the inside, then there is a steady diffusion of hydrogen through the platinum component outwards, so that there can no longer be an equilibrium situation for water dissociation. Thereby an enrichment of oxygen occurs on the melt-facing side of the platinum component. If the solubility limit of oxygen in the glass melt is exceeded, then oxygen bubbles form on the platinum. This new bubble formation is referred to as oxygen reboil. The oxygen bubbles that arise in the glass melt can ultimately reach the glass end product, whereby the yield and quality of the glass are considerably impaired, which is above all intolerable for optical glasses or display glasses. Another approach to an explanation starts from the assumption of a catalytic effect of the platinum on the water present in the glass melt. The catalytic effect of the platinum is based on a dissociation of water into its components that is favored by the platinum.

Above all, borosilicate glasses, aluminosilicate glasses and glass ceramics are affected by this. Among the borosilicate glasses, the neutral glasses important for pharmacy, engineering and chemistry, and also many others not belonging to the neutral glass group, have a particularly strong tendency for bubble formation. In the aluminosilicate glasses, glasses that are suitable for display applications and that are used for thermally highly stressed lamps are particularly affected. Furthermore, all glasses that do not contain a sufficiently high concentration of polyvalent ions and have not been sufficiently refined tend to form oxygen bubbles on platinum surfaces.

It has already been attempted to suppress oxygen reboil by countermeasures.

A method in which the decomposition of water deliberately takes place in the refining tub on a hollow body made of noble metal is described in DE 10231847. The decomposition of water can be regulated by applying a potential or by adjusting the temperature of the tube. Hydrogen is conducted to the exterior through the tube. The oxygen remaining in the glass rises up as bubbles. This method has proven to be expensive, however.

DE 19955827 describes a method for suppressing oxygen bubble formation at the glass melt-noble metal contact surface in which the noble metal component is electrically connected to an electrode arranged a certain distance away from the noble metal component and a potential drop is generated. If a sufficiently large electrically negative potential difference with respect to the glass melt is maintained at the noble metal, then the oxygen left over after the decomposition of water and the diffusion of hydrogen is ionized. The oxygen ions are soluble in an unlimited amount in the fluid glass and do not form any oxygen bubbles. This method has the disadvantage that the potential difference to be set up depends very strongly on the composition of both the glass and the noble metal, and is therefore difficult to adjust. Furthermore, impurities can be introduced into the glass due to electrode corrosion and can lead to changes in the glass properties.

DE 10141585 describes a double-jacket tube for guiding glass melts, in which the inner tube and the cavity between the inner tube and the outer tube are filled with the glass melt. Decomposition of water takes place at the noble metal-glass interface, but the glass melt between the two tube walls prevents diffusion of hydrogen out of the inner tube, so long as equal hydrogen partial pressures prevail on both sides of the noble metal inner tube. This method has proven to be expensive to implement in terms of construction, however.

An additional method for avoiding bubble formation at the platinum is described in document DE 10032596. In this case, a glass-conducting channel is constructed from two interpenetrating tubes. A seamless tube of, for example, quartz is used for glass contact. The outer tube, by means of which the heating of the channel takes place via electrical heating, consists of noble metal. The glass melt is separated from the noble metal tube by the seamless tube. The disadvantage of this system lies in the high inertia of the system with regard to temperature control.

WO 02/44115 describes how oxygen bubble formation on platinum metals can be avoided by a coating that is impermeable to H₂ or H₂ and O₂ on the side of the components facing away from the melt. Glass or a glass mixture are mentioned as possible coatings. The coating serves as a diffusion barrier and is intended to prevent oxygen bubble formation. The disadvantages of this method are that, in order to obtain proper functioning of the layer, the application of the aforementioned coatings is very expensive, the coating must be flawless and the handling of the components during installation must be very careful so that no defects arise. Damage to the layer during operation causes failure of the protection system.

Another method for avoiding reboil bubbles is presented in DE 10003948. It is shown that the oxygen reboil tendency of a glass melt decreases if the glass melt is raised to temperatures of over 1700° C. before homogenization and conditioning, and if the glass melt additionally contains polyvalent ions such as vanadium cerium, zinc, titanium, iron, molybdenum or europium. This method has the disadvantage that it is only applicable to certain glasses, and higher temperatures during refining can only be achieved with a high expenditure for apparatus. Another measure for avoiding the formation of oxygen bubbles is the deliberate enrichment of the side facing away from the glass with hydrogen. This can be accomplished, as described in U.S. Pat. No. 5,785,726, by dribbling water onto the component surface, or by flushing it with a hydrogen-containing gas. In that way, the motive force for the hydrogen diffusion is supposed to be suppressed. As a rule, however, the process window is very narrow and the water decomposition is dependent on the glass composition, the temperature and the environmental conditions on the side of the platinum component facing away from the glass. If the hydrogen content at the glass-platinum interface is less than on the side of the component facing away from the glass, the hydrogen diffuses into the glass melt, and there can be bubble formation due to hydrogen, or reactions of the hydrogen with components of the glass can occur. This can lead to a deterioration of the glass quality up to and including an interruption of production. Another problem is that local alloy formations with glass components reduced by the hydrogen, such as antimony, arsenic, lead, tin, vanadium, tellurium, iron, etc., can occur at the noble metal surface. This results in the mechanical or thermomechanical reduction of the stability of the noble metal, or complete destruction of the material structure in case of strong corrosion. The consequence is a shorter service life of the components and thus a premature renovation with correspondingly high costs. If the temperature distribution for a component is inhomogeneous, this can result in different process windows for the colder and the warmer areas, so that different atmospheres at the exterior of the component are necessary. It has been shown in practice that the process can only be regulated with great difficulty. Despite adjusting a defined hydrogen-containing atmosphere on the side of the platinum component facing away from the glass, oxygen bubble formation can still usually be observed.

The known methods thus either lead to a change in the glass composition and therefore in the product properties, and are thus applicable only to a limited extent, or are technologically elaborate, must be monitored and controlled and are correspondingly expensive. Loss of production results in case of malfunctions of control and regulation.

### DESCRIPTION OF THE INVENTION

Against this background, the present invention has posed the problem of providing a method and a device for transporting, homogenizing and/or conditioning preferably inorganic melts, particularly glass or glass ceramic melts, which avoid the above-mentioned disadvantages of prior art.

In particular, the method and device should be suitable for transporting, homogenizing and/or conditioning optical glasses and/or display glasses.

In particular, this comprises the objective of preventing the new formation of bubbles, particularly oxygen bubbles in the glass melt after refining, or of at least reducing the amount of newly formed bubbles in the glass melt to a minimum.

In addition, the method and the device for performing it should be applicable flexibly, i.e., to different types of glass melts or to glass melts of different properties, most importantly with regard to viscosity, temperature and/or corrosiveness of the melt.

The method and the device for performing it should furthermore be economically rational and economical to use.

This problem is solved in a surprisingly simple manner by the method for transporting, homogenizing and/or conditioning according to the preamble of Claim 1 and by the device according to the preamble of Claim 30 for performing the method. Advantageous embodiments are the subject matter of the respective subordinate claims.

In a first embodiment, the invention comprises a method for transporting, homogenizing and/or conditioning an inorganic melt, in particular, a glass melt and/or a glass ceramic melt. The method is characterized in that by means of at least one wall or section of a wall of a transport device and/or homogenizing device and/or conditioning device that is provided with a diffusion barrier layer comprising iridium, a dwell time of the melt in the transport device and/or homogenizing device and/or conditioning device is adjusted such that the oxygen partial pressure in the melt has a value less than 1 bar. This is achieved in that the diffusion barrier layer at least reduces the diffusion of hydrogen through the wall in comparison to conventional wall materials such as platinum or platinum alloys.

The dwell time in this regard is the individual residence time of the glass melt in the transport device and/or homogenizing device and/or conditioning device. The dwell time can be regulated and/or controlled by the flow speed of the melt, among other things. The oxygen partial pressure indicates the concentration at which the oxygen is present in the glass melt.

The method is advantageously characterized in that the new formation of bubbles after refining at a contact surface of the melt with a wall of the transport device, homogenization device and/or conditioning device comprising iridium as material is at least reduced or even completely avoided.

In particular, the diffusion of hydrogen through the wall of a transport device, homogenization device and/or conditioning device is at least reduced or even suppressed by the diffusion barrier layer. A diffusion barrier layer in the sense of the application is an obstacle to the diffusion of gases, preferably hydrogen, from one side of the diffusion barrier layer, more particularly, that which faces the melt, to the other side of the diffusion barrier layer, more particularly, that which faces away from the melt.

In a preferred embodiment, the melt-facing side of the diffusion barrier layer is provided at least in certain sections with a melt contact surface. In this case, the diffusion barrier layer forms the layer constituting the melt contact, or the melt contact layer of the wall. The melt is thus brought into contact with a medium for preventing new formation of bubbles, at least one section of the melt contact surface being provided as a material comprising iridium.

In a preferred embodiment, the diffusion barrier layer is provided as a component of the walls of the transport device and/or homogenization device and/or conditioning device, at least in the area of the melt contact layer. The device has walls having a material comprising iridium, at least in the area of the melt contact layer. In an advantageously particularly simple refinement, the walls of the transport device and/or homogenization device and/or conditioning device consist of iridium.

A melt contact layer is understood as an interface layer having at least one melt contact surface, or touching or contacting the melt at least in sections over its surface. The walls or the aforementioned transport, homogenization and/or conditioning devices in the sense of the present application not only comprise the corresponding containers, tubs or tubing, but also corresponding components that are in contact with the melt or at least have a melt contact surface, such as stirrer parts, channels, feeders, needles, nozzles, tweels, glass level gauges or stirrers.

As noble metals, iridium or iridium alloys has or have a substantially higher chemical resistance to glass melts than platinum or platinum alloys. Additionally, the thermal stress resistance of iridium or its alloys is substantially higher than that of platinum or platinum alloys. Iridium components can be heated to a temperature of ca. 2200° C. in contact with glass melts. Even at these high temperatures, the attack of the glass melts on the metal is advantageously extremely low.

The elevated temperature stress resistance of iridium or an iridium alloy in comparison, for example, to platinum or a platinum alloy is of central importance in the transport, homogenization and/or conditioning devices according to the invention. The operation of the method according to the invention takes place at a temperature in the melt of ca. 700° C. to roughly 1700° C., preferably of 1100° C. to roughly 1700° C. In a preferred embodiment, the operation takes place at a temperature of roughly 1300° C. to roughly 1500° C.

Moreover, iridium dissolved in glass has no substantial coloring influence in the visible range and thus does not produce any substantial discoloration of glasses. This proves particularly advantageous in an embodiment in which the diffusion barrier layer comprising iridium has a melt contact surface over its melt-facing side.

In addition, experiments that were conducted show a detectable inclusion of platinum of 9 ppm in glasses that were incubated for one hour at a temperature of 1480° C. in a PtIr1 crucible (99 wt % Pt, 1 wt % Ir), while no iridium was detectable in the glasses. In a melt that was incubated in an iridium crucible under the same conditions, 4 ppm of iridium alongside 0.3 ppm of platinum were detectable. The iridium corresponds to the specification described in WO 2004/007782 A1. This result demonstrates that when iridium is used as the melt contact material or in a melt contact surface of the crucible, a substantially smaller material removal from the crucible wall takes place, and therefore fewer metallic components and metallic ions are detectable in the end product, or glass. This advantageously results in a longer service life of an iridium crucible. Furthermore, the inventors recognized, on the one hand, that the formation of streaks in the glass melt can be considerably reduced or even completely avoided at a surface which has iridium or an iridium alloy as its material. On the other hand, the inventors found that the formation of oxygen bubbles is considerably reduced or even completely suppressed at a surface which has iridium or an iridium alloy as its material, in contrast to a surface having platinum or a heavily platinum-containing alloy.

The melt flows, preferably after refining, through the corresponding transport, homogenization and/or conditioning device, which can be implemented as a tub, a channel or a container, for example. The new formation of bubbles at conventional platinum walls or platinum alloy walls is reduced or even completely suppressed by means of the iridium-comprising diffusion barrier layer arranged on the side of the platinum wall facing away from the melt.

The inventors recognized that the formation of bubbles can be effectively reduced if the diffusion barrier layer is provided with a content of iridium of roughly 10% to roughly 100%, preferably of roughly 30% to 100%, particularly preferably of roughly 50% to 100% by weight.

If the iridium content corresponds to a content of less than roughly 98% to roughly 100% by weight, then one has an iridium alloy. At least platinum, rhodium, gold, yttrium, ruthenium, palladium, zirconium, niobium, tungsten, tantalum, hafnium, titanium, lanthanum, molybdenum, rhenium, aluminum, and/or silicon or a combination of the aforesaid materials, particularly at least two of the aforesaid materials, are accordingly provided as additional materials for the layer forming the diffusion barrier or the diffusion barrier layer.

Without being bound to a theory, it is assumed that the difference between iridium and platinum is based on the fact that due to its high density, iridium has a diffusion-reducing or even a diffusion-inhibiting effect on the hydrogen present in the melt. Iridium thus represents a barrier to hydrogen diffusion. The dissociation of water into its components as well as the corresponding reverse reaction consequently remains in equilibrium in the area of the wall. No oxygen can be enriched, and thus no bubbles can form. A detailed description in this regard is found in the exemplary embodiment. Under the assumption of a catalytic effect of platinum on the water present in the glass melt, iridium could not have this catalytic effect.

In one embodiment, the diffusion barrier layer is provided such that it has a content of iridium that gradually decreases from the melt-facing side of the diffusion barrier layer in the direction of a side of the diffusion layer facing away from the melt. The side facing away from the melt is the side or the area of the wall which is directed towards the outside of the wall or has no contact surface with the melt. The content of iridium is thus not homogeneously distributed in the diffusion barrier layer, but rather decreases little by little from the melt-facing side of the diffusion barrier layer perpendicular to the melt contact surface in the direction of the side of the diffusion barrier layer facing away from the melt. The content of iridium can decrease uniformly or in discrete steps. The variation of the iridium content allows a targeted adjustment of the chemical resistance, preferably with respect to the melt, and the diffusion properties, in particular, with respect to hydrogen gas.

Correspondingly, the layer with the gradually decreasing content of iridium is characterized in that the iridium is provided in the melt-facing side of the diffusion barrier layer at a content of roughly 10% to roughly 100%, preferably of roughly 30% to roughly 100%, particularly preferably of roughly 50% to roughly 100% by weight, and in that iridium is provided in the side of the diffusion barrier layer facing away from the melt at a content of less than roughly 5%, preferably of less than 2.5%, particularly preferably of less than roughly 1.5% by weight.

In another embodiment, the diffusion barrier layer is provided with a content of iridium that gradually increases from a melt-facing side of the diffusion barrier layer in the direction of a side of the diffusion barrier facing away from the melt. The diffusion barrier layer described here is thus provided as the inverse of the diffusion barrier layer described in the previous paragraph. It has substantially the same properties. It differs, however, in that iridium is provided in the melt-facing side at a content of less than roughly 5 wt %, preferably of less than 2.5 wt %, particularly preferably of less than 1.5 wt %, and in the side of the diffusion barrier layer facing away from the melt at a content of roughly 10 wt % to roughly 100 wt %, preferably of roughly 30-100 wt %, particularly preferably of roughly 50-100 wt %.

In a special embodiment of the present invention, the diffusion barrier layer is divided such that it consists completely of iridium, or correspondingly, has an iridium content of roughly 98-100% by weight.

The diffusion barrier layer can also be constructed or designed such that it even forms the wall directly, i.e., without an additional substrate or substrate layer. In other words, the wall consists of a one-layer system, or a monolayer system, and the diffusion barrier layer is formed sufficiently thick that it alone forms the wall. The wall corresponding to the single-layer system of the invention is provided with a thickness of roughly 0.1 mm to roughly 500 mm, preferably of roughly 0.2 mm to roughly 200 mm, particularly preferably of roughly 0.3 mm to roughly 10 mm.

It is not necessary according to the invention, however, to provide the wall as a single-layer system. The wall can be equally well constructed layer by layer or be constructed or formed by an arrangement of individual layers.

If the wall is accordingly constructed as a multi-layer system, i.e., the wall comprises at least a two-layer system, then it is characterized in that the wall is provided with at least one carrier layer. The carrier layer is assigned in this case substantially the supporting function of a wall, i.e., the carrier layer substantially provides the wall with its mechanical stability. In other words, the carrier layer is the framework of the wall on which additional layers are deposited, disposed and or applied as needed.

The carrier layer is formed by at least one refractory material. A refractory material in the sense of the invention is a heat-resistant or thermally stable material. As a refractory material, a group of materials is provided that comprises a brick, preferably a refractory brick, a ceramic, preferably a refractory ceramic, a glass, silica glass in particular, a glass ceramic, a metal, preferably Pt or Rh, a refractory metal and/or a metal alloy, preferably steel, special steel, Ni-based alloy, Co-based alloy, Pt and/or Rh. In an alternative embodiment, the carrier layer is formed by the diffusion barrier layer. The group of refractory materials comprises the following metals: titanium, zirconium, hafnium, vanadium, chromium, tungsten, molybdenum, tantalum, niobium and rhenium.

In order to guarantee a sufficient mechanical stability, the carrier layer is provided with a thickness of roughly 0.05 mm to roughly 50 mm, preferably of roughly 0.05 mm to roughly 10 mm, particularly preferably of roughly 0.1 mm to roughly 1 mm, depending on the material. Depending on the requirements, the carrier layer can also be provided with a thickness of up to roughly 0.5 m or roughly 1 m.

In one embodiment, the diffusion barrier layer is applied to the carrier layer. In another embodiment, the wall is characterized in that it is provided with at least one protective layer. This protective layer prevents oxidation of the diffusion barrier layer by the oxygen contained in the ambient air, since iridium is not oxidation-stable above 1000° C. relative to oxygen. The protective layer also has a diffusion-inhibiting or even blocking effect with respect to oxygen. The protective layer is an oxidation protection layer.

According to the invention, the functions with regard to chemical resistance to the melt, diffusion and/or stability can also be realized by means of only one layer with an appropriate selection of material.

A variety of methods are available for the formation or deposition of the diffusion barrier layer and/or the protective layer. To produce a particularly dense, strong and uniform layer, however, the aforementioned layers are deposited by means of PVD, in particular, by means of sputtering, vapor deposition and or ionic plating. In another embodiment, the aforementioned layers are deposited and/or applied by means of CVD, in particular, PICVD, casting, plating and/or galvanizing. In a preferred embodiment, the diffusion barrier layer and/or the protective layer is deposited by means of a thermal spraying method, in particular means of arc and/or plasma spraying. The diffusion barrier layer and/or the protective layer is or are deposited at a thickness of roughly 0.1 μm to roughly 30,000 μm, preferably of roughly 1 μm to roughly 1000 μm, particularly preferably of roughly 50 μm to roughly 500 μm.

The protective layer is formed by at least one refractory material, comprising a ceramic, a glass, in particular a mullite glass, a metal oxide, in particular aluminum oxide, calcium oxide, cerium oxide, dichromate oxide, hafnium dioxide, magnesium oxide, silicon dioxide, thorium dioxide, zirconium oxide, and/or spinel, a metal, preferably Pt, Rh, Ru, zirconium and/or palladium, a refractory metal, a metal alloy, preferably comprising steel, special steel, Pt and/or Rh, Ni-based alloy and/or Co-based alloy, or a combination of said materials, in particular at least two of said materials.

In order to protect the diffusion barrier layer from oxidation by the oxygen contained in the air, a defined atmosphere can be produced in the area of an exposed side of the diffusion barrier layer, i.e. facing away from the melt and in contact with the environment, or in the exposed area of a melt contact layer of the diffusion barrier layer. The defined atmosphere is produced by means of a fluid, in particular a gas, preferably nitrogen, an inert gas, preferably argon or helium, and/or a forming gas, preferably forming gas (95/5) or (90/10). A temperature control of the melt can also be accomplished via the flow of the fluid. The use of a mixture of the above-mentioned gases is also reasonable. The device for transporting, homogenizing and/or conditioning can also be arranged in a space that separates the device for transporting, homogenizing and/or conditioning from the environment and in which the defined atmosphere is produced or applied.

In one embodiment the defined atmosphere is provided by means of a fluid curtain, in particular a gas curtain. Thus, the defined atmosphere is produced only locally in the area of the exposed side of the diffusion barrier layer facing away from the melt. The fluid is conducted in a tubing system, channels or a porous material, preferably a bed, mortar, a molding compound and/or a stamping compound. Preferred embodiments are constituted of ceramic oxides.

The present invention further comprises a device for transporting, homogenizing and conditioning a melt, in particular a glass melt and or a glass ceramic melt, which is characterized in that at least one section of the wall of the transport device, homogenizing device and/or conditioning device comprises at least one diffusion barrier layer having at least iridium as a component. The diffusion barrier layer lowers or reduces the diffusion of hydrogen through the wall of the transport device, homogenizing device and/or conditioning device relative to a conventional wall made of platinum or platinum alloy. The device is particularly suited for performing the above-described method.

The diffusion barrier layer preferably represents a diffusion barrier layer for hydrogen. A diffusion barrier layer in the sense of the application is an obstacle to the diffusion of gases, preferably hydrogen, from one side of the diffusion barrier layer, more particularly, that which faces the melt, to the other side of the diffusion barrier layer, more particularly, that which faces away from the melt. With a diffusion barrier layer, the diffusion of hydrogen through the diffusion barrier layer is at least reduced. Relative to platinum, a platinum alloy or relative to a platinum wall or platinum alloy wall, the diffusion barrier layer has at least a reduced hydrogen permeability.

In one embodiment of the invention, the melt-facing side of the diffusion barrier layer is, at least in certain sections, the melt contact surface of the wall of the device for transporting, homogenizing and conditioning.

In a preferred embodiment, the diffusion barrier layer is provided, at least in the area of the melt contact layer, as a component of the walls of the transport device and/or homogenization device and/or conditioning device. The device has walls having a material comprising iridium, at least in the area of the melt contact layer. In an advantageously particularly simple refinement, the walls of the transport device and/or homogenization device and/or conditioning device consist of iridium.

The device is characterized in that the diffusion barrier layer has an iridium content of roughly 10% to roughly 100%, preferably of roughly 30-100%, particularly preferably of roughly 50-100% by weight. The diffusion barrier layer can thus consist of iridium. If, however, the diffusion barrier is an alloy of iridium, then it comprises at least platinum, rhodium, gold, yttrium, ruthenium, palladium, zirconium, niobium, tungsten, tantalum, hafnium, titanium, lanthanum, molybdenum, rhenium, aluminum, and/or silicon or a combination of the materials, preferably at least two of the aforesaid.

In one embodiment, the diffusion barrier layer has a content of iridium that gradually decreases from the melt-facing side of the diffusion barrier layer in the direction of the side of the diffusion layer facing away from the melt. The diffusion layer has a content of iridium in the melt-facing side of the diffusion barrier layer of roughly 10% to roughly 100%, preferably of roughly 30% to 100%, particularly preferably of roughly 50% to 100% by weight, while the content of iridium in the side of the diffusion barrier layer facing away from the melt has a content of less than roughly 5%, preferably of less than roughly 2.5%, particularly preferably of less than 1.5% (percent by weight).

Another embodiment according to the invention is characterized in that the diffusion barrier layer has a content of iridium that gradually increases from a melt-facing side of the diffusion barrier layer in the direction of a side of the diffusion barrier facing away from the melt. In the melt-facing side of the diffusion barrier layer, iridium has a content of less than roughly 5 wt %, preferably of less than 2.5 wt %, particularly preferably of less than 1 wt %. In the side of the diffusion barrier layer facing away from the melt, iridium has a content of roughly 10 wt % to roughly 100 wt %, preferably of roughly 30-100 wt %, particularly preferably of roughly 50-100 wt %.

In another embodiment, the wall itself is formed only of the diffusion barrier layer, which then has a corresponding thickness. The wall has a thickness of roughly 0.1 mm to roughly 5 mm, preferably roughly 0.2 mm to roughly 2 mm. In a particularly preferred embodiment, the wall has a thickness of roughly 0.3 mm to roughly 1 mm.

In another embodiment of the present invention, the wall can be constructed not only of one layer, but rather of an arrangement of individual layers, thus at least of two layers.

The wall correspondingly has at least one carrier layer. The carrier layer is formed or constructed of at least one refractory material. The refractory material comprises a brick, preferably a refractory brick, a ceramic, preferably a refractory ceramic, a glass, silica glass in particular, a glass ceramic, a metal, preferably Pt or Rh, a refractory metal and/or a metal alloy, preferably steel, special steel, Ni-based alloy, Co-based alloy, Pt and/or Rh. In another embodiment according to the invention, the carrier layer comprises or is the diffusion barrier layer. Depending on the embodiment, the carrier layer can have a thickness of up to roughly 0.5 m or roughly 1 m. In a preferred embodiment, the carrier layer has a thickness of roughly 0.05 mm to roughly 50 mm, preferably of roughly 0.05 mm to roughly 10 mm, particularly preferably of roughly 0.1 mm to roughly 1 mm.

In another embodiment, the wall has, in the case of an at least two-layer construction. at least one protective layer or, in case the diffusion barrier layer does not form the carrier layer, the diffusion barrier layer is arranged on the carrier layer. The diffusion barrier layer and/or the protective layer is deposited or applied by means of PVD, in particular, by means of sputtering, vapor deposition or ionic plating. The diffusion barrier layer and/or the protective layer can additionally be deposited by means of CVD, in particular, PICVD, casting, plating and/or galvanizing, or by means of a thermal spraying method, in particular, by means of arc spraying and/or plasma spraying. The diffusion barrier layer and/or the protective layer according to the invention have a thickness of roughly 0.1 μm to roughly 30,000 μm, preferably of roughly 1 μm to roughly 1000 μm, particularly preferably of roughly 50 μm to roughly 500 μm. The protective layer has at least one refractory material.

The refractory material comprises a ceramic, a glass, in particular mullite glass, a metal oxide, in particular aluminum oxide, calcium oxide, cerium oxide, dichromate oxide, hafnium dioxide, magnesium oxide, silicon dioxide, thorium dioxide, zirconium oxide, and/or spinel, a metal, preferably Pt, Pd, Ru, zirconium and/or palladium, a refractory metal and/or a metal alloy, preferably comprising steel, special steel, Ni-based alloy, Co-based alloy, Pt and/or Rh. Depending on the embodiment, the diffusion barrier layer and/or the protective layer form a materially adhesive bond with the carrier layer and/or to one another.

Corresponding to another embodiment, the diffusion barrier layer is arranged in a defined atmosphere that has the already described properties. The defined atmosphere comprises a fluid, in particular, a gas, preferably nitrogen, an inert gas, preferably argon or helium and/or a forming gas.

In one embodiment the defined atmosphere has a fluid curtain, in particular a gas curtain. Thus, the defined atmosphere is produced only locally in the area of the exposed side of the diffusion barrier layer facing away from the melt. The fluid is conducted in a tubing system, channels or a porous material, preferably a bed, mortar, a molding compound and/or a stamping compound. Preferred embodiments are constituted of ceramic oxides.

The device and the method according to the present invention are suited particularly for transporting, homogenizing and/or conditioning borosilicate glasses, aluminosilicate glasses, aluminoborosilicate glasses, aluminosilicon silicate glasses, aluminolithium silicate glasses, optical glasses, glass ceramics and/or glasses with a content of polyvalent ions of less than roughly 5 wt %. The aforesaid glasses find application in displays, flat glass, optical glass elements, glass ceramic cooktops, fireplace viewing panes, thermally highly stressed lamps, industrial components with high requirements, in fire protection and/or in pharmacy. The above-mentioned glasses and applications are to be understood only for the sake of example, and are by no means limited to the above-mentioned selection.

The invention further comprises a glass, in particular an optical glass, which can be manufactured, or more particularly has been manufactured, with the method of the invention or by means of the device of the invention. Said glass is distinguished in that at least the bubbles contained in the glass have a bubble diameter of less than roughly 25 μm, preferably less than roughly 10 μm, particularly preferably less than roughly 5 μm. Bubbles of said dimensions have a substantially negligible influence on the optical and/or mechanical properties of an optical glass element manufactured with the method of the invention. The bubble inclusion is determined by means of a visual inspection. Therein, the glass is placed with its underside on a black background and is illuminated from the side. The glass is viewed from the upper side of the glass in the direction of the black background. The bubbles become visible as bright dots. The size of the bubbles is measured under a microscope by means of a scale.

Bubbles present in the glass need not always contain only oxygen as the gas. Oxygen can be replaced for instance by other components of the melt as well, so that oxygen-containing gases such as CO₂, N₂, SO₂ can be contained in the bubbles. The bubble diameter in the sense of the present invention can be determined as the diameter of a bubble assumed to be spherical. It is also possible to employ the longest extension of the bubble to determine the bubble diameter.

If the melt-facing side of the diffusion barrier layer corresponds to the melt contact surface of the wall, then the glasses produced with the method of the invention or by means of the device of the invention are distinguished by a reduced inclusion of undesired coloring substances, particularly elemental or ionic platinum, in addition to freedom from bubbles. If the diffusion barrier layer has a melt contact surface, the glasses include a content of iridium of 1 ppm to 500 ppm, preferably of 1 ppm to 100 ppm, particularly preferably of 2 ppm to 20 ppm. If the diffusion barrier layer takes on the function of a protective layer for a melt contact surface of a platinum or platinum alloy wall, the glasses contain a platinum content of less than 50 ppm, preferably less than 20 ppm, particularly preferably of less than 10 ppm.

Also lying within the scope of the invention is the use of iridium as at least one constituent of a diffusion barrier layer of a wall in a device and/or in a method for transporting, homogenizing and/or conditioning a melt, in particular a glass melt and/or a glass ceramic melt, wherein a dwell time of the melt in the transport device and/or homogenizing device and/or conditioning device is adjusted such that the oxygen partial pressure in the melt has a value of less than roughly 1 bar.

If the melt contact surface of the wall is formed by platinum or platinum alloy, or if the wall consists of platinum or platinum alloy, then the new formation of bubbles after refining can be reduced or avoided by jacketing or encapsulating the wall with a diffusion barrier layer. This is based on the inhibitory effect of iridium with respect to the diffusion of hydrogen.

If the melt-facing side of the diffusion barrier layer forms the melt contact surface of the wall, then the formation of bubbles is prevented due to the inhibitory effect with regard to hydrogen diffusion and the formation of streaks is additionally prevented by its metallic surface on the melt contact surface.

The diffusion barrier layer comprising iridium takes on the function of at least a bubble-reduction layer or even a bubble-prevention layer, or is a bubble reduction layer or bubble prevention layer. If the melt-facing side of the diffusion barrier layer is also the melt contact surface of the wall, then the diffusion barrier layer also takes on the function of at least a streaking reduction layer or even a streaking prevention layer or is at least a streaking reduction layer or streaking prevention layer.

Alongside the quality with regard to bubbles, streaking and freedom from platinum, the glasses produced with the method of the invention or by means of the device of the invention are distinguished in that the glass has a water proportion or water content that substantially corresponds to the water content that the glass melt has after refining, and the melt enters into a closed system, i.e., a system that is not in contact with the environment.

The present invention will be described below in detail on the basis of exemplary embodiments, wherein the characteristics of the different exemplary embodiments can be combined with one another. For this purpose, reference is made to the appended drawings. Identical reference characters in the individual drawings refer to identical parts.

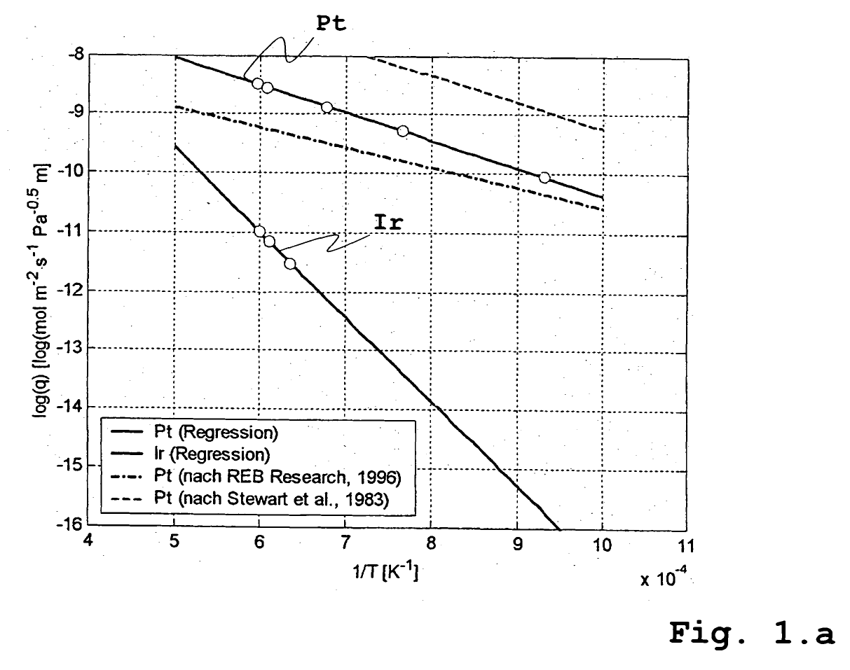

FIG. 1a shows the result of a study of hydrogen permeability as a function of temperature.

FIG. 1b shows an additional result of a study of hydrogen permeability as a function of temperature.

FIG. 1c shows for the sake of example an oxygen partial pressure measurement as a function of time.

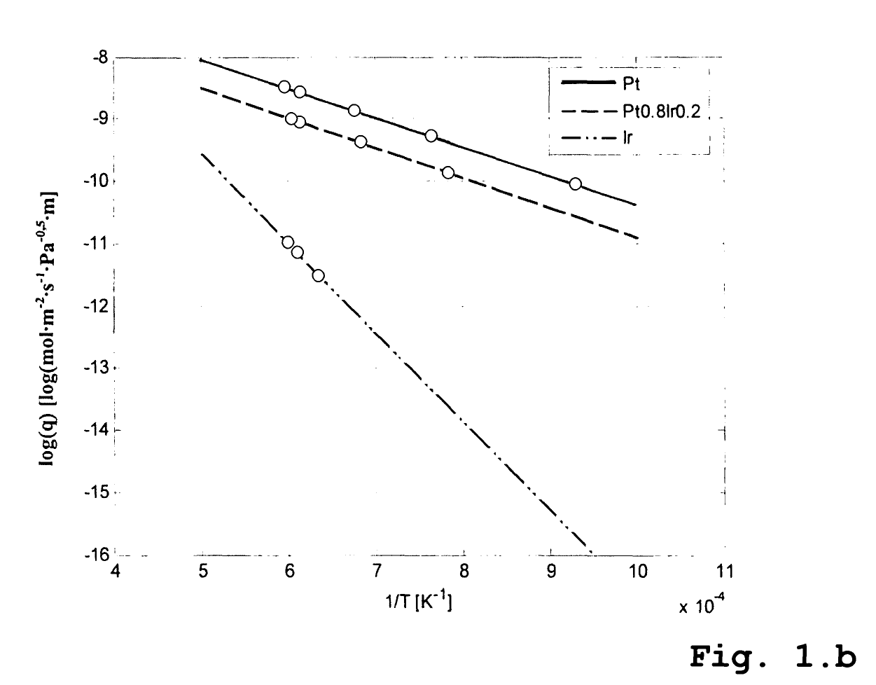

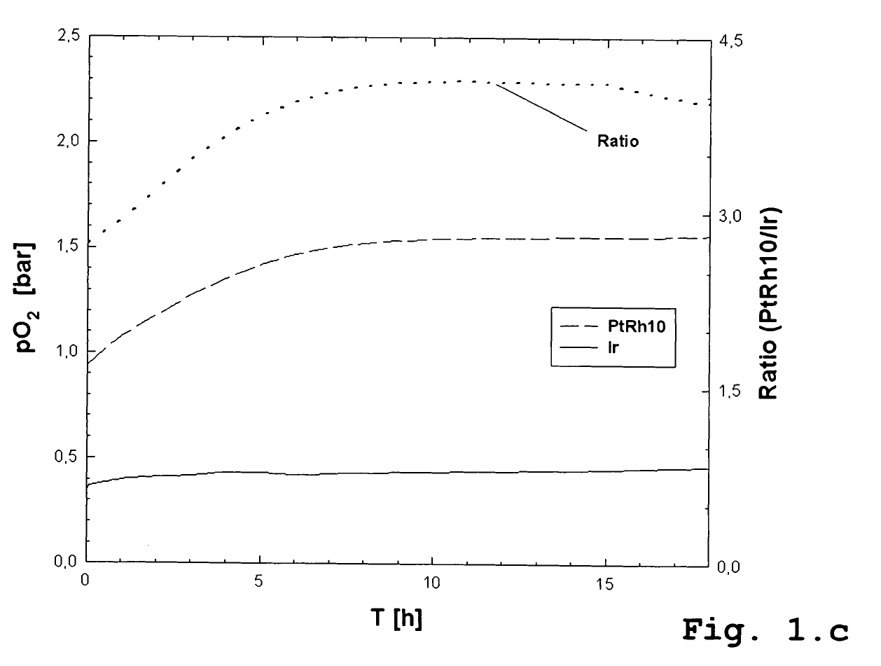

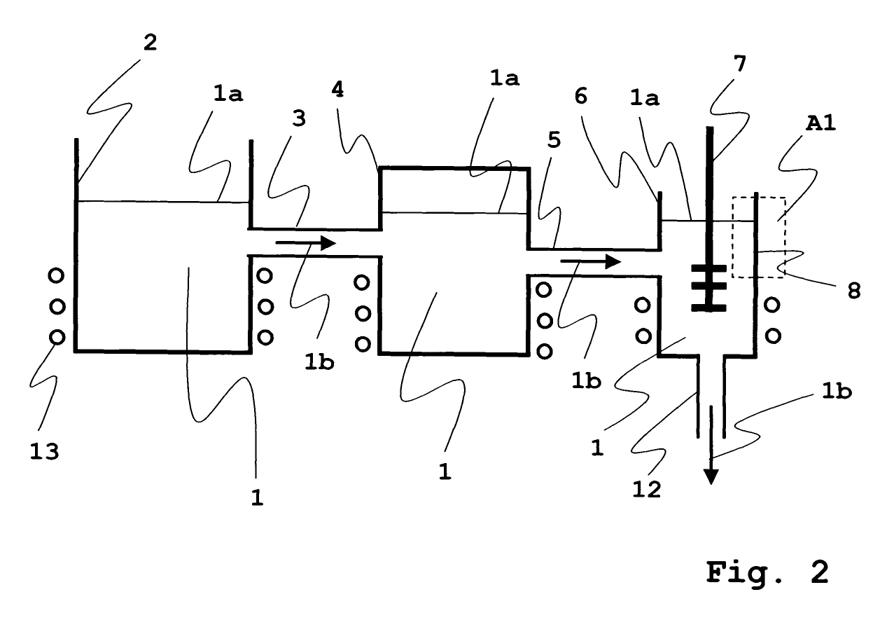

FIG. 2 shows for the sake of example a schematic representation of the individual process steps or processed devices in glass manufacturing (melting crucible, refining crucible, homogenizing device, conditioning tub, channels).

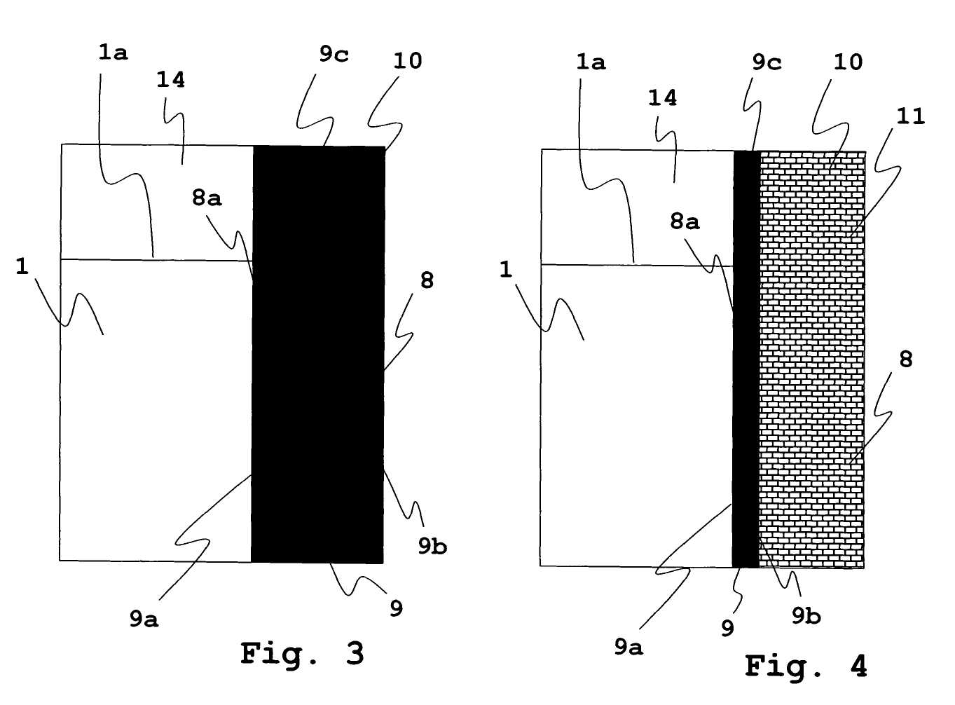

FIG. 3 shows a schematic detail view of section A1 from FIG. 2 with an exemplary embodiment as a single-layer system

FIG. 4 shows a schematic detail view of section A1 from FIG. 2 with an exemplary embodiment as a double-layer system.

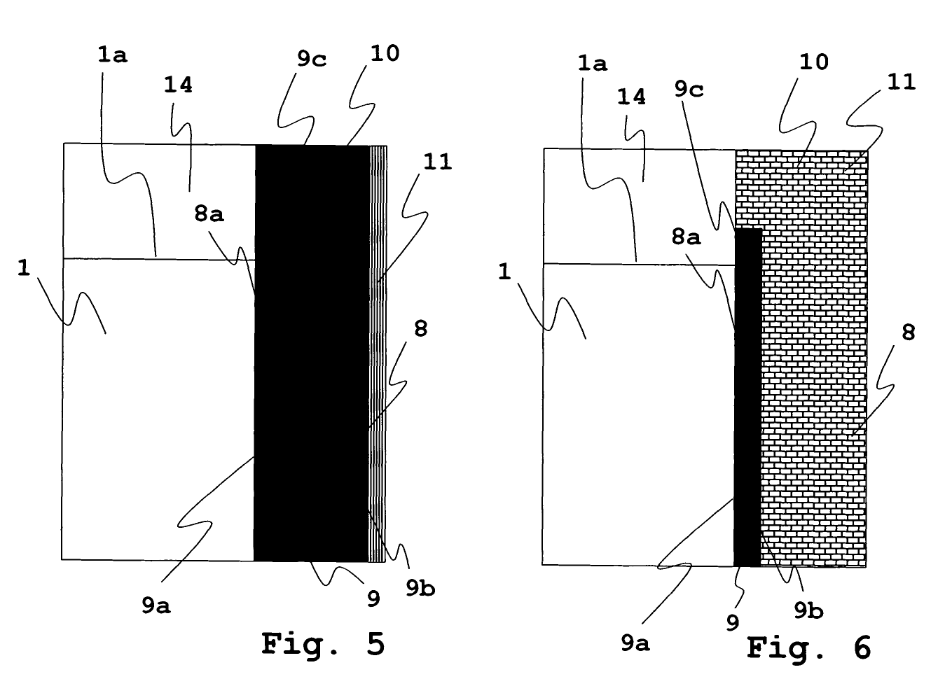

FIG. 5 shows a schematic detail view of section A1 from FIG. 2 with an additional exemplary embodiment as a double-layer system.

FIG. 6 shows a schematic detail view of section A1 from FIG. 2 with an exemplary embodiment as a double-layer system in certain sections.

FIG. 6 shows a schematic detail view of section A1 from FIG. 2 with an exemplary embodiment as a double-layer system in certain sections.

FIG. 8 shows a schematic detail view of section A1 from FIG. 2 with an exemplary embodiment as a three-layer system.

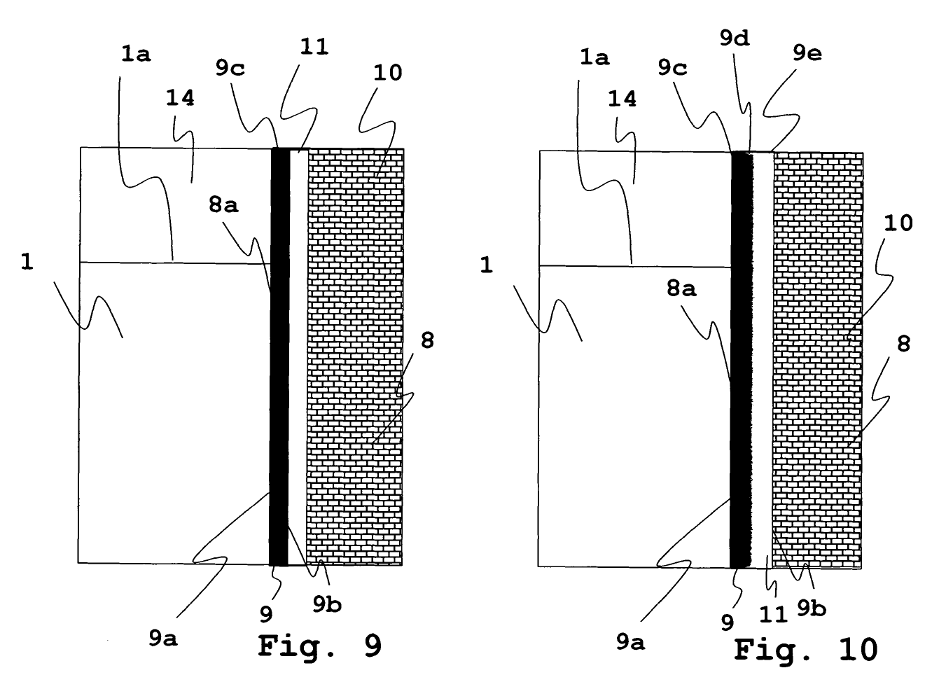

FIG. 9 shows a schematic detail view of section A1 from FIG. 2 with an additional exemplary embodiment as a three-layer system.

FIG. 10 shows a schematic detail view of section A1 from FIG. 2 with an additional exemplary embodiment as a double-layer system having a layer with gradually decreasing Ir content.

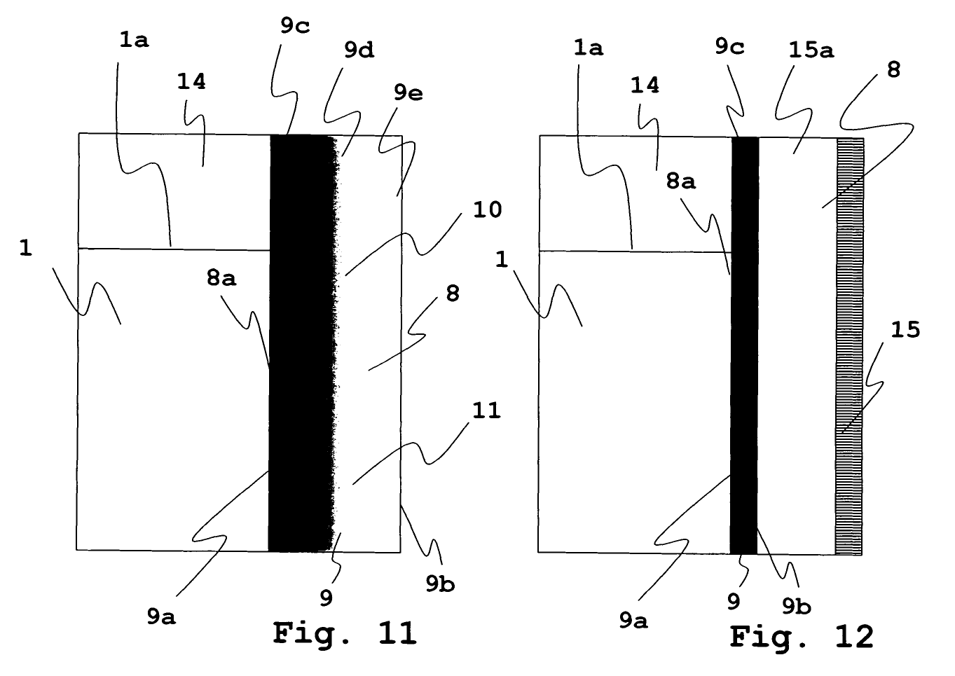

FIG. 11 shows a schematic detail view of section A1 from FIG. 2 with an additional exemplary embodiment of a layer with gradually decreasing Ir content.

FIG. 12 shows a schematic detail view of section A1 from FIG. 2 with an additional exemplary embodiment with an encapsulation.

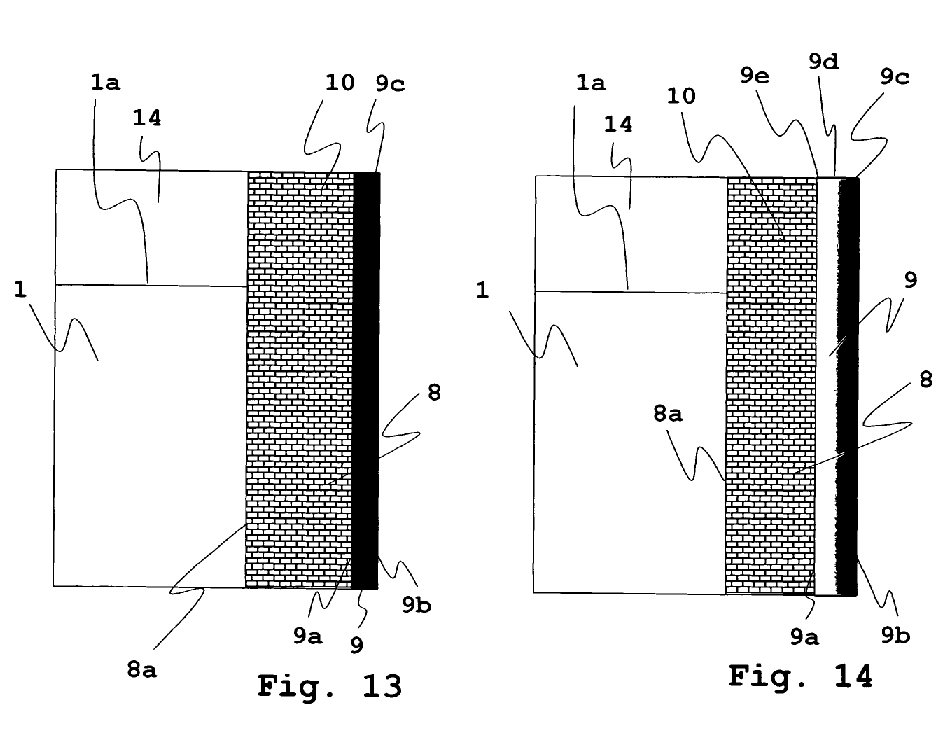

FIG. 13 shows a schematic detail view of section A1 from FIG. 2 of an exemplary double-layer system, comprising a carrier layer and an externally arranged iridium-comprising diffusion barrier layer.

FIG. 14 shows a schematic detail view of section A1 from FIG. 2 with an additional exemplary embodiment as a double-layer system having a layer with gradually increasing Ir content.

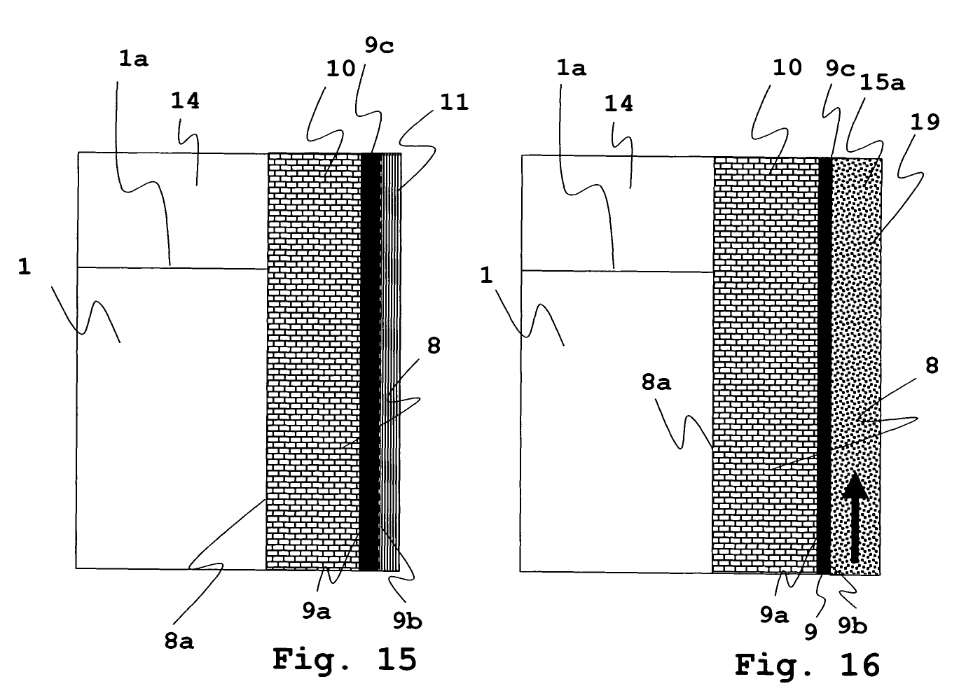

FIG. 15 shows an exemplary three-layer system that corresponds to the layer system in FIG. 13 with an additionally arranged external protective layer.

FIG. 16 shows the layer system from FIG. 13 with an additionally arranged external porous material.

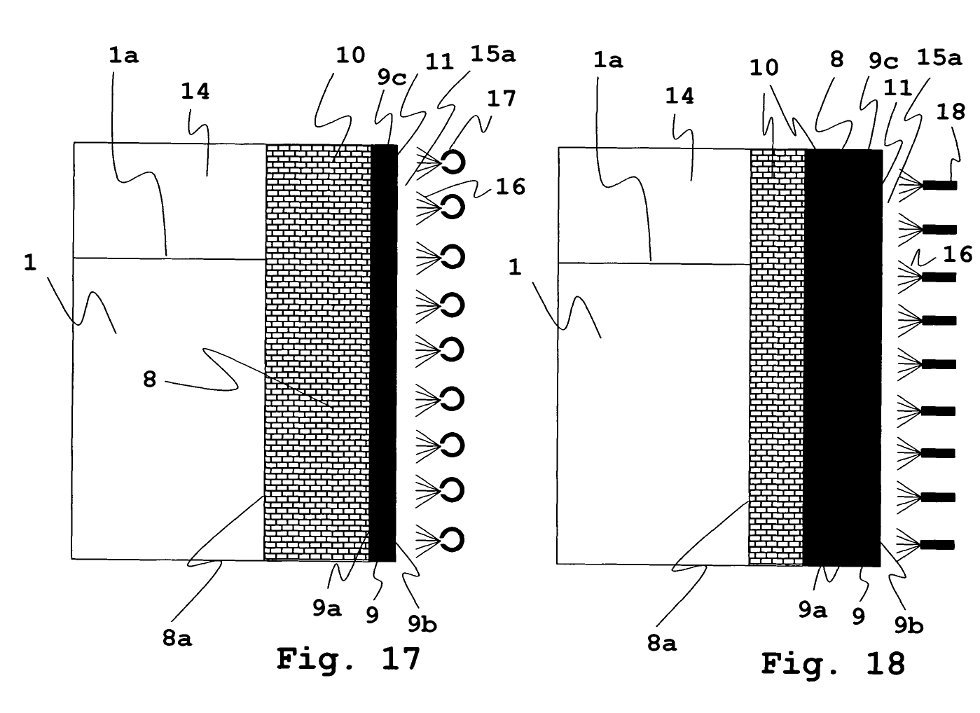

FIG. 17 shows the layer system from FIG. 13 with an additionally arranged fluid curtain.

FIG. 18 shows a layer system in an additional embodiment with an additionally arranged fluid curtain in an additional embodiment.

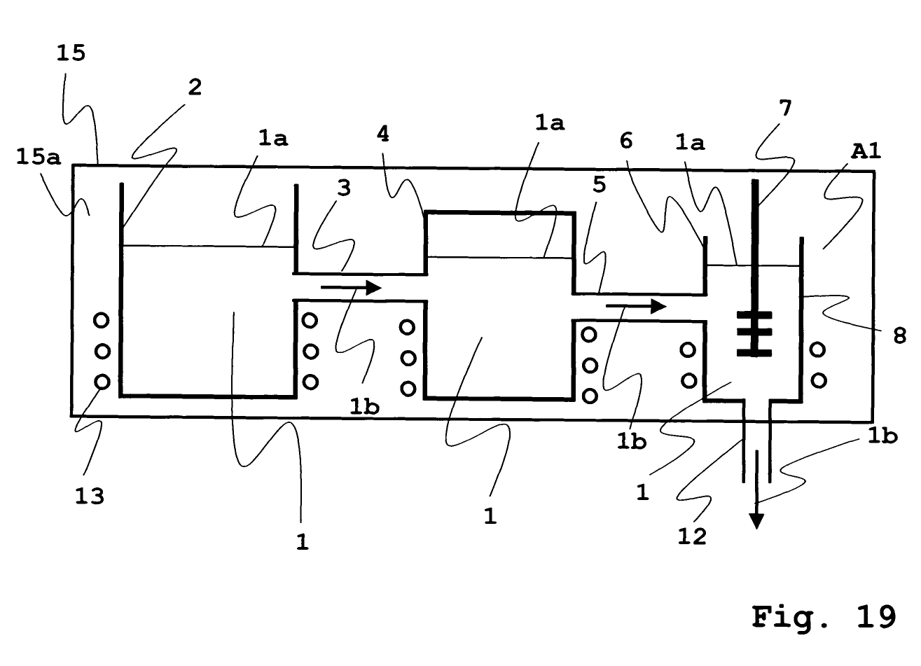

FIG. 19 shows the device from FIG. 2 with a schematic representation of an encapsulation and a defined atmosphere.

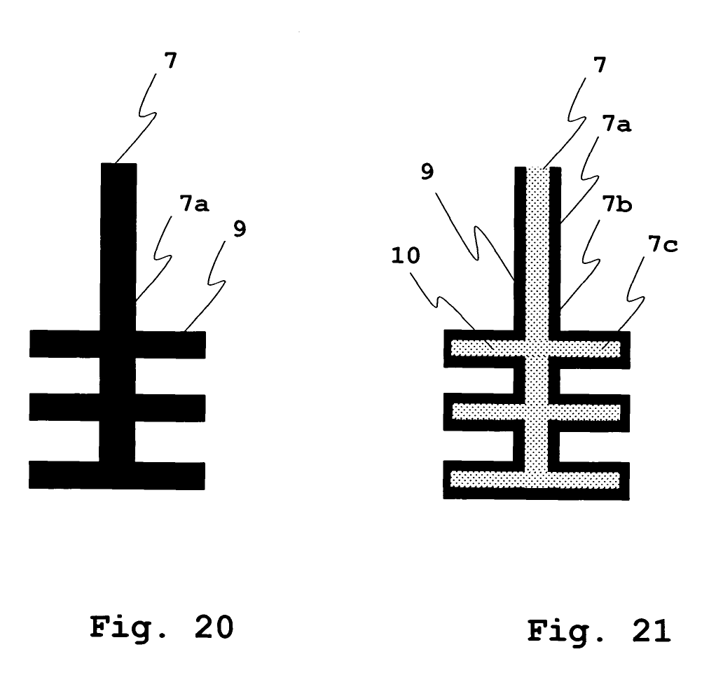

FIG. 20 schematically shows the stirring device from FIG. 2 in an enlarged representation.

FIG. 21 schematically shows the stirring device from FIG. 2 in an enlarged representation with an additional exemplary embodiment as a double-layer system.

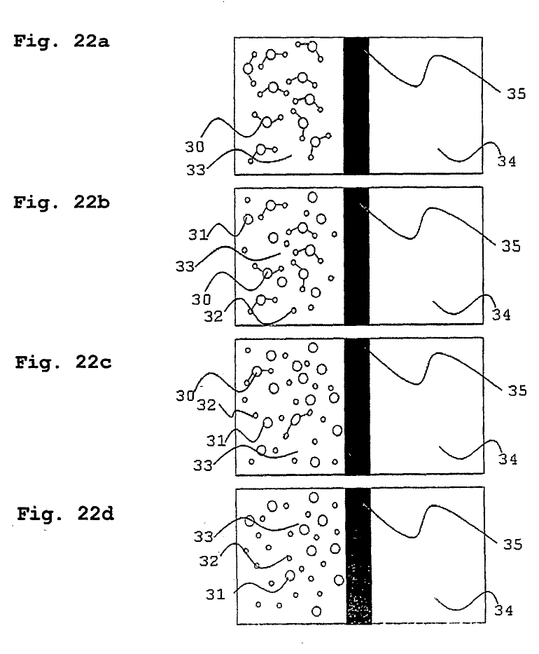

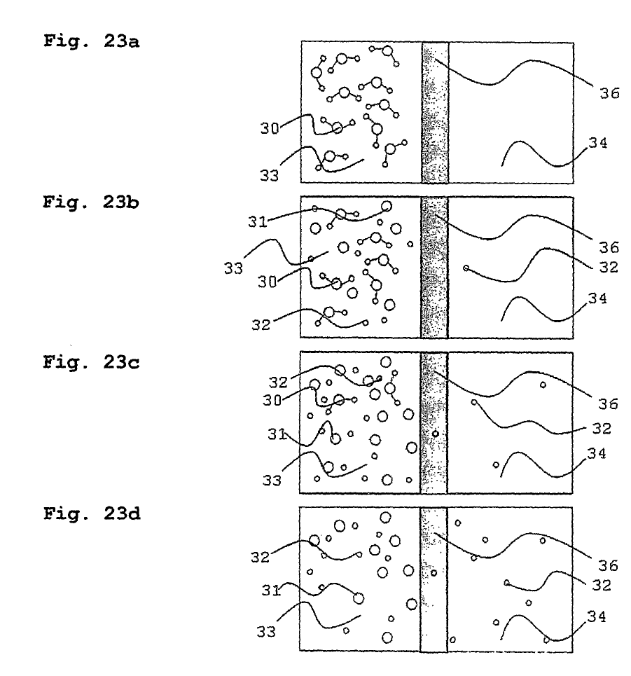

FIG. 22 schematically shows the diffusion-inhibiting effect of a wall comprising iridium.

FIG. 23 schematically shows the diffusion of hydrogen through a platinum wall.

FIG. 1a shows the result of a study of the stationary permeation of hydrogen through tubular samples of platinum and iridium in a temperature range of roughly 800° C. to roughly 1400° C. The tubular samples are arranged in a tubular furnace, the maximum accessible temperature of which lies at roughly 1400° C. The flow through the apparatus takes place according to the countercurrent principle. The hydrogen permeability of the two samples is shown as a function of temperature. The two additionally plotted functions without symbols mark the curve of the hydrogen permeability according to diagrams available in the literature.

The experimentally determined values are shown as symbols and were extrapolated both to low and to high temperatures. At temperatures below 1300° C., however, iridium has a hydrogen permeability that is barely measurable with the experimental setup that was available.

It is clearly recognizable, however, that the iridium tube, as an example of a device with iridium walls, or of iridium itself has a substantially lower permeability than is displayed by the platinum tube or platinum. Proceeding from the fitting of the experimental data, iridium or the iridium tube has a hydrogen permeability in a temperature range from roughly 1100° C. to roughly 1700° C. that it is reduced relative to platinum or the platinum tube by roughly 3.7-1.6 orders of magnitude. In a temperature range from roughly 1300° C. to roughly 1500° C., iridium or the iridium tube has a hydrogen permeability that it is reduced relative to platinum or the platinum tube by roughly 2.8-2.2 orders of magnitude. At the maximum accessible study temperature of about 1400° C., iridium or the iridium tube has a hydrogen permeability that it is reduced relative to platinum or the platinum tube by roughly 2.5 orders of magnitude.

FIG. 1b shows an additional result of a study of hydrogen permeability as a function of temperature. The study was carried out under the same conditions as the results illustrated in FIG. 1a. Here a tubular sample consisting of 80% platinum and 20% iridium was used. The hydrogen permeability of the sample is shown as a function of temperature. The values shown there for iridium and platinum correspond to the values that were already shown in FIG. 1a. Even an alloy having a content of only 20% iridium shows a hydrogen permeability clearly lower than that of platinum in the measured temperature range of roughly 1000° C. to roughly 1400° C. It corresponds to a hydrogen permeability of roughly 31% to roughly 35% of the hydrogen permeability of platinum. Interpolating and extrapolating the data, the reduced value of hydrogen permeability for Pt_{0.8}Ir_{0.2} of roughly 31% to roughly 35% relative to the hydrogen permeability of platinum is also present in a temperature range of roughly 1100° C. to roughly 1700° C., or roughly 1300° C. to roughly 1500° C.

Taking into account the data shown above, it becomes clear that an additional increase in the iridium content leads to a further reduced hydrogen permeability. Starting from a content of iridium or roughly 20% up to a content of roughly 100%, the hydrogen permeability of the corresponding alloy comprising iridium lies between the above-mentioned values.

This data demonstrate for the first time the blocking effect or diffusion-reducing effect of iridium for hydrogen as compared to platinum. Iridium thus represents a diffusion barrier for hydrogen. This result is confirmed by a study of the oxygen partial pressure present in a glass melt.

FIG. 1b shows for the sake of example the measurement result of an oxygen partial pressure measurement pO₂ as a function of time T. A PtRh10 tube and an Ir tube were dipped into a glass melt with a temperature of roughly 1430° C. The glass melt in this case comprised an aluminosilicate glass. The value of the oxygen partial pressure pO₂ is indicated by the left ordinate, while the right ordinate provides information on the ratio of the oxygen partial pressures. It is clearly visible that the oxygen partial pressure pO₂ in the melt area of the Ir tube is reduced relative to the PtRh10 tube. The oxygen partial pressure in the melt was determined by means of a lambda probe.

The oxygen partial pressure for the PtRh10 tube is initially larger by a factor of roughly 2.7 relative to the Ir tube. After roughly 6 to 8 hours, the factor is roughly 4.1. For iridium or the iridium tube, the oxygen partial pressure in the melt is reduced as compared to platinum, here the platinum alloy PtRh10 or the PtRh10 tube, by a factor of roughly 2.7 to roughly 4.1. The oxygen partial pressure is an indirect indicator of the diffusion of hydrogen through the tube wall made of platinum, wherein additional influences such as the amount and solubility of the hydrogen in the melt, or transport phenomena in the melt must be taken into account. Moreover, this is a platinum alloy. This prompts the conjecture that permeability is influenced by the content of other metals, rhodium in this case. The data demonstrate the blocking effect or diffusion-reducing effect of iridium for hydrogen as compared to platinum in a glass melt.

The motive force necessary for bubble formation is based on a temporary oversaturation of the melt with gases. One parameter is the corresponding oxygen or gas partial pressure The value of oxygen partial pressure pO₂ of ≈1 bar represents a limit range for the glass melt that was examined, from or in which a new bubble formation begins, substantially due to the oxygen dissolved in the glass. For the glasses mentioned in the part of the description above, this limit value of pO₂≈1 bar proves to be relevant. The critical value is dependent on the existing environmental conditions. The value of pO₂≈1 bar was determined under standard atmosphere or standard conditions of roughly 1 atm.

The initial value for the platinum tube lies at a pO₂ value of roughly 0.95 bar and thus in the critical range of roughly pO₂≈1 bar. The bubble formation or the new bubble formation begins immediately. After a short time, roughly 20 to 30 minutes, the oxygen partial pressure even exceeds the value of 1 bar. On the contrary, the value of the oxygen partial pressure for the iridium tube in the illustrated time interval of up to T≈18 h lies at a mean value of pO₂≈0.4 bar, or in an interval of pO₂≈0.34 bar to pO₂≈0.47 bar. The value of the oxygen partial pressure for the iridium tube lies markedly below 1 bar, and the formation of bubbles can consequently be effectively suppressed or at least reduced over a time period of up to 18 hours.

The system that was studied is static. Accordingly, the dwell time for the present glass system or the glass melt that was investigated and the above-mentioned glasses is not critical in the temperature range of 1430° C. in a flowing or streaming system like the glass melt in the transport device, homogenizing device and/or conditioning device. The dwell time is dependent, however, on the flow rate of the melt, the temperature in the melt, the glass type and the dimensions and geometry of the devices.

The dwell time in this regard is the individual residence time of the glass melt in the transport device and/or homogenizing device and/or conditioning device. The mean dwell time is the quotient of the device volume and volume flow of the glass melt flowing through the device. The dwell time is significant for the rate and the selectivity of chemical reactions. A performance of the method that is optimal in terms of time expended is further enabled by regulating and/or controlling and/or adjusting the dwell time distribution of the melt in the vessel. In additional comparative measurements on components of iridium and platinum, the inventors were able to show for the first time that the blocking effect of the iridium with respect to hydrogen diffusion leads to a prevention of bubble formation at the interface between the melt and glass. This effect could not be found when platinum tubes were used. Then bubbles were observed at the interface between metal and melt, from which it clearly follows that platinum is more permeable to hydrogen than is iridium.

An iridium-comprising surface or an iridium-comprising melt contact layer 9 takes on the function of a diffusion barrier layer for hydrogen and is thus a bubble-reduction layer or a bubble-prevention layer. This also comprises the use of iridium in melt contact surface 8a, preferably in the area of a wall 8 in contact with a melt 1, for minimizing. or under certain circumstances, even preventing the formation of bubbles in the wall-melt area or in the interaction between wall 8 and melt 1.

FIG. 2 shows for the sake of example a schematic representation of the individual process steps in glass manufacturing, or a system for melting, transporting, refining, homogenizing and conditioning glass or a melt or a glass melt 1.

Homogenization is understood as the dissolution and uniform distribution of all components, as well as the elimination of streaks. Conditioning a melt or glass melt is understood to be the adjusting of the melt temperature as quickly and accurately as possible. This is the case in channel systems of glass melting installations, for example, when melting and refining processes are finished and the glass must be brought to a desired forming temperature.

The first process step in glass production is the melting of the precursor substances, the so-called batch, in a melting crucible 2. When the batch has already become viscous, a first slow homogenization of the melt 1 begins. An open melting crucible 2 with an open melt surface 1a is shown by way of example.

There must be thorough intermixing and degassing of the glass melt 1 in order to achieve maximum homogeneity and freedom from bubbles. Therefore, the melting is generally followed by the refining and homogenization of the glass melt 1. Melt 1 or glass melt 1 is accordingly supplied via a first channel 3 along the melt-flow or flow direction 1b of melt 1 to a device for refining, a refining tub 4 with a cover in this case. The essential goal of the refining is to remove from melt 1 the gases that are physically and chemically bound to it. A further homogenization of glass melt 1 can also take place in refining tub 4.

After the bubbles in the melt have been removed by the refining, the new formation of bubbles in the melt is now to be prevented or at least reduced. The melt 1 or glass melt 1 is supplied via a second channel 5 along the melt flow direction 1b to the actual homogenization device 6. In the present case, the latter comprises a stirring device 7 arranged in a tub that serves to homogenize and condition glass melt 1 and to remove streaks from glass melt 1.

Via a conditioning device 12, constructed for the sake of example as an additional channel, melt 1 is supplied along the melt-flow direction 1b to, for example, a forming device, not shown here, and is brought to the required forming temperature in conditioning device 12. Accordingly, first channel 3, second channel 5 as well as homogenization device 6 can take on the function of a conditioning device 12.

In the present case, the heating of the system for melting, transporting, refining, homogenizing and conditioning glass 1 or glass melt 1 takes place inductively by means of a coil system 13 that is arranged, but not shown in part, around each of the respective devices 2, 3, 4, 5, 6, 12.

The heating can also take place conductively, conventionally or by means of a combination of said methods.

The subsequent FIGS. 3-11 each show a schematic detail view of section A1 from FIG. 2, with an exemplary embodiment of the present invention in each case. Section A1 is shown as a section of a wall 8 of homogenization device 6, but a wall 8, a bottom or a cover of melting crucible 2, first channel 3, refining tub 4, second channel 5, stirrer 7, conditioning device 12 and/or a connecting element, not shown here, between the individual devices can be so constructed.

Depending on the design, diffusion barrier layer 9 can comprise a melt contact surface 8a over its melt-facing side 9a, at least over certain sections. Melt contact surface 8a describes in each case the surface or side via which diffusion barrier layer 9 is in contact with or touches melt 1. Opposite melt-facing side 9a of diffusion barrier layer 9 lies the side 9b of diffusion barrier layer 9 that faces away from the melt.

According to the invention, diffusion barrier layer 9 comprises the constituents iridium or an iridium alloy as materials, and consequently represents an iridium-containing wall section 9c, or a section of wall 8. Alongside pure iridium, the iridium alloys listed in the following publications have proven particularly advantageous: JP 08116152, WO 2004/007782 A1, U.S. Pat. No. 3,970,450 A1, U.S. Pat. No. 4,253,872 A1, U.S. Pat. No. 5,080,862 A1, EP 732416 B1, DE 3301831 A1, U.S. Pat. No. 6,071,470 A1, U.S. Pat. No. 3,918,965 A1 and U.S. Pat. No. 6,511,632 B1.

The figures each show the wall 8 that forms the boundary of homogenization device 6 or of the container of homogenization device 6, the glass melt 1, the melt surface 1a and a space 14 formed between melt surface 1a and wall 8.

In the space 14 formed between melt surface 1a, wall 8 and a cover of the corresponding device, not shown here, a defined atmosphere can be maintained. In order, for instance, to avoid the oxidation of iridium or iridium alloy-based components, an atmosphere of a protective gas, in particular, nitrogen, argon, helium or forming gas (95/5 or 90/10) or a negative pressure can be generated in space 14.

FIG. 3 shows a first exemplary embodiment of the present invention. The illustrated wall 8 is constructed in this case as a one-layer system. This one-layer system is formed by diffusion barrier layer 9. Accordingly, diffusion barrier layer 9 also takes on the bearing or supporting of wall 8, or is thus also a carrier layer 10 in the sense of the present application. In other words, the wall consists of iridium or an iridium alloy with the above-mentioned properties. A thermally, chemically and mechanically stable wall 8 of iridium has a thickness of roughly 0.3 mm to roughly 1 mm. For a wall with the above-mentioned constituent of an iridium alloy, a thickness of roughly 0.3 mm to roughly 1 mm has also proven advantageous.

FIG. 4 shows an exemplary embodiment of wall 8 as a double-layer system or two-layer system. Here, wall 8 or a section of wall 8 comprises diffusion barrier layer 9 and a carrier layer 10 that is arranged on side 9b of diffusion barrier layer 9 facing away from the melt. Alternatively, diffusion barrier layer 9 is arranged on carrier layer 10. Carrier layer 10 thus assumes both a supporting or bearing function as well as a protective function. This first of all comprises the advantage that the iridium-comprising diffusion barrier layer 9, which is not oxidation-resistant with respect to the oxygen in the ambient air above roughly 1000° C., is protected by carrier layer 10 from oxidation. Second, diffusion barrier layer 9 can be arranged or deposited by means of a method disclosed in the description (PVD, CVD, thermal spraying) in such a manner that the thickness is minimal, but is still sufficiently thermally, chemically and mechanically stable and still sufficiently diffusion-inhibiting for the hydrogen present in the melt. This reduces material costs with respect the amount of iridium or iridium alloy to be paid for. A thickness of diffusion barrier layer 9 of roughly 50 μm to roughly 500 μm has proven sufficiently stable. On the other hand, no requirements with respect to a high chemical resistance are placed on the material of carrier layer 10, since diffusion barrier layer 9 takes on a protective function for carrier layer 10. Only with regard to temperature stability are requirements placed that are comparable to those for diffusion barrier layer 9, as well as higher requirements with respect to inhibiting or even blocking the diffusion of oxygen. The temperature stability of carrier layer 10 can also be oriented to the necessary processing temperature for melt 1. Accordingly, diffusion barrier layer 10 also takes on a protective function for diffusion barrier layer 9 of wall 8, or is thus also a protective layer 11 in the sense of the present application. A preferred material for carrier layer 10 is, for example, a refractory brick or a refractory metal such as molybdenum, tungsten, special steel, Ni-based alloy, Co-based alloy, Pt and/or Pt alloy. With regard to the thickness of carrier layer 10, a value of 0.1 mm to roughly 1 mm has proven itself, independently of the material used.

FIG. 5 shows an additional exemplary embodiment of the present invention as a two-layer system. Corresponding to diffusion barrier layer 9 from FIG. 3, the present diffusion barrier layer 9 also takes on the bearing or supporting of wall 8, or is thus also a carrier layer 10 in the sense of the present application. The thickness of diffusion barrier layer 9 here has a value of roughly 0.3 mm to roughly 1 mm. A protective layer 11 is arranged on the side 9b of diffusion barrier layer 9 facing away from the melt. This external coating protects diffusion barrier layer 9 from oxidation by the oxygen contained in the ambient air. Protective layer 11 is an oxidation protection layer. No requirements with respect to high chemical resistance are placed on protective layer 10, since it does not come into contact with the melt. Only with regard to temperature stability are requirements placed that are comparable to those for diffusion barrier layer 9, as well as higher requirements with respect to diffusion-inhibiting or even blocking of oxygen, or of gases such as hydrogen escaping from the melt. The temperature stability of protective layer 11 can also be oriented to the necessary processing temperature for the melt. Preferred materials for protective layer 11 here comprise the materials platinum, molybdenum, tungsten, special steel, a Pt alloy, a Ni-based alloy and/or a Co-based alloy. Depending on the material, the external coating has a thickness of 50 μm to roughly 500 μm. Protective layer 10 can be deposited by means of a method disclosed in the description (PVD, CVD, thermal spraying).

FIG. 6 shows a possible construction of wall 8 analogous to FIG. 4, but with the difference that diffusion barrier layer 9 is provided essentially only in the section of wall 8 or of the wall 8 formed by carrier layer 10 in which wall 8 is in contact with glass melt 1. Thus, a protection of diffusion barrier layer 9 in the area above melt surface 1a by means of a defined atmosphere in space 14 is not necessary. Moreover, the material costs for iridium or iridium alloy can be reduced because of a smaller surface area to be covered.

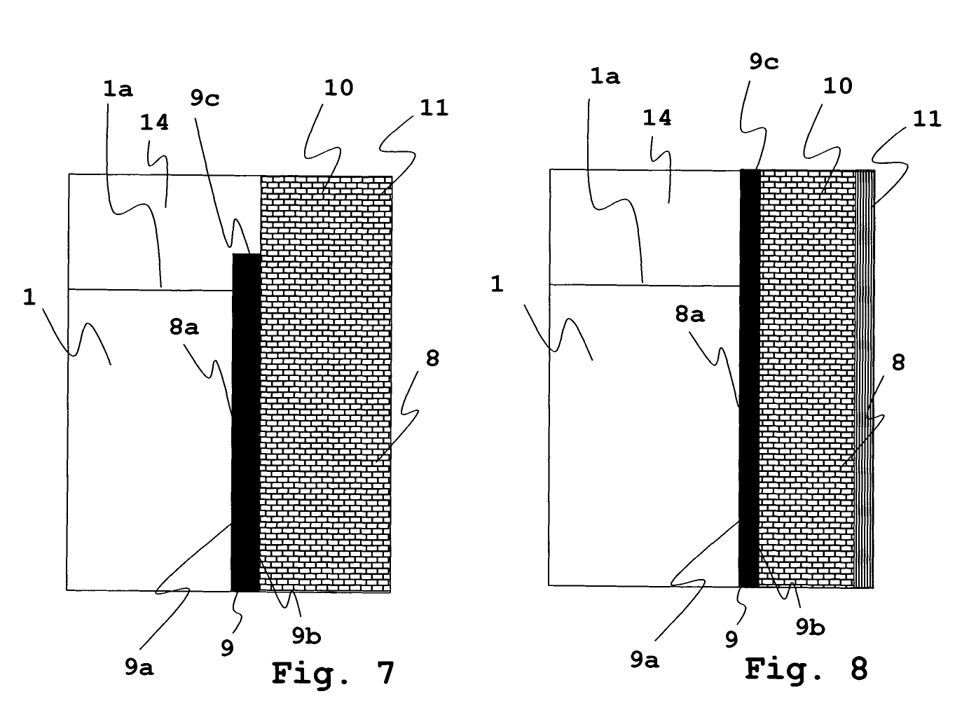

FIG. 7 shows a possible construction of wall 8 analogous to FIG. 6, but with the difference that diffusion barrier layer 9 is not inserted into wall 8 or into the wall 8 formed by carrier layer 10, which represents a reduced expense in production.

FIG. 8 shows an exemplary embodiment of a three-layer system of the present invention. The present layer system of wall 8 represents a combination of the layer systems illustrated in FIGS. 4 and 5: diffusion barrier layer 9, a carrier layer 10 and a protective layer 11. Diffusion barrier layer 9 is arranged or deposited on carrier layer 10 via its side 9b facing away from the melt. Protective layer 11 is arranged or deposited on the outer side of carrier layer 10. Carrier layer 10 takes on the bearing and/or supporting function of wall 8, while protective layer 11 takes on a diffusion-reducing or even diffusion-inhibiting function, particularly for oxygen. The properties with respect to diffusion and bearing or supporting of wall 8 are thus guaranteed separately by two layers, protective layer 11 and carrier layer 10. Requirements comparable to those on diffusion barrier layer 9 are placed on protective layer 11 and carrier layer 10 only with regard to temperature stability. The temperature stability of protective layer 11 and carrier layer 10 can also be formed according to the necessary processing temperature of the melt, however.

FIG. 9 shows an additional exemplary embodiment of a three-layer system or three-layer construction of wall 8 corresponding to FIG. 8. In the present case, protective layer 11 is arranged between diffusion barrier layer 9 and carrier layer 11. In addition to the properties of protective layer 11 already mentioned in the description of FIG. 8, it can also produce an adhesion-promoting effect between carrier layer 10 and diffusion barrier layer 9.

FIG. 10 shows an exemplary embodiment of wall 8 as a two-layer system. Although in two layers, the fundamental principle is analogous to that of the three-layer system of FIG. 9. Instead of two discrete layers, diffusion barrier layer 9 and protective layer 11, the present layer system of wall 8 has only one layer, which unites both the function of diffusion barrier layer 9 and that of protective layer 11. It is characterized in that the melt-facing side 9a of diffusion barrier layer 9 forms the melt contact surface 8a of wall 8, and represents an iridium-containing section 9c. It therefore has a sufficient resistance to melt 1 and reduces the formation of bubbles and/or streaks. Side 9b of diffusion barrier layer 9 that faces away from the melt represents an iridium-free section 9e in order to protect iridium-containing section 9c from oxidation and reduce or even suppress the diffusion of gases. A low-iridium section 9d is situated between iridium-free section 9e and iridium-containing section 9c. The content of the iridium gradually decreases from melt contact surface 8a of the wall, or melt-facing side 9a of diffusion barrier layer 9, in the direction of side 9b facing away from the melt. The generation of such a layer is possible, for example, by varying the parameters of a PVD or CVD-based deposition.

Analogously to FIG. 10, FIG. 11 shows another exemplary embodiment of a layer with gradually decreasing iridium content. In this case, wall 8 is formed by the layer 9, 10, 11 of gradually decreasing iridium content. Accordingly, the functions of a diffusion barrier layer 9, a carrier layer 10 and a protective layer 11 are realized in one layer.

FIG. 12 shows a schematic detail view of section A1 from FIG. 2 with an additional exemplary embodiment. In order to suppress oxidation of diffusion barrier layer 9 via its side 9b facing away from the melt, a defined atmosphere 15a as described with regard to space 14 can be provided. The provision or generation of defined atmosphere 15a is provided by arranging an encapsulation 15, which can be produced from steel, Ni-based alloy, Co-based alloy or special steel.

In the above-described FIGS. 3-12, melt-facing side 9a of diffusion barrier layer 9 forms melt contact surface 8a of wall 8. In these figures, diffusion barrier layer 9 is a melt contact layer. The formation of bubbles can advantageously be minimized or suppressed by such a melt contact layer comprising iridium or consisting of iridium by means of its diffusion-inhibiting effect for hydrogen, and the formation of streaks can also be minimized or suppressed by means of the metallic surface of the melt contact surface.

In the FIGS. 13-18 described below, melt-facing side 9a of diffusion barrier layer 9 does not form a melt contact surface 8a of wall 8. In such an embodiment, only the diffusion-inhibiting and thus bubble-preventing effect of diffusion barrier layer 9 takes effect. If the respective carrier layer 10 consists of a material permeable to hydrogen such as platinum or platinum alloy, then bubble formation appears mainly in the wall area of melt 1 due to the diffusion of hydrogen out of the melt or glass to the outside through wall 8. By arranging a diffusion barrier layer 9 comprising iridium or consisting of iridium on the outside of such a wall 8, a loss of hydrogen from melt 1 is substantially prevented and thus the formation or new formation of bubbles in the melt is substantially suppressed. Diffusion barrier layer 9 can particularly advantageously be retrofitted into systems already in operation.

FIG. 13 shows a schematic detail view of section A1 of an exemplary two-layer system from FIG. 2, comprising a carrier layer 10, preferably platinum or a platinum alloy, and a diffusion barrier layer 9 comprising iridium or consisting of iridium, arranged on the outer side of carrier layer 10.

FIG. 14 shows a schematic detail view of section A1 from FIG. 2 with an additional exemplary embodiment as a two-layer system which has a carrier layer 10 and in which a layer with a gradually increasing Ir content is arranged on its outer side.

In order to prevent oxidation of an exposed side 9b of diffusion barrier layer 9 facing away from the melt, it can be encapsulated with a protective layer 11, for example. FIG. 15 shows an exemplary three-layer system for this purpose, which corresponds to the layer system of FIG. 13 with an additional externally arranged protective layer 11. Possible materials for protective layer 11 were already mentioned with regard to FIGS. 3-12.

Another possibility for avoiding the oxidation of iridium or iridium alloy-based components, or of the exposed side 9b of diffusion barrier layer 9 facing away from the melt, can be produced by providing a defined atmosphere 15a in the space that surrounds side 9b facing away from the melt. Possible embodiments of a defined atmosphere 15a have already been described; also refer to FIG. 19 among others.

FIG. 16 shows the layer system in FIG. 13 for this purpose, with an additional externally arranged porous material 19, in the form of a bed for instance, in which a defined atmosphere 15a is produced. For instance, a fluid with the appropriate properties can flow through porous material 19 along the direction of the arrow. Thus, a defined atmosphere 15a is produced only locally or in a limited space and prevents oxidation of side 9b of diffusion barrier layer 9 facing away from the melt.

A bed consists of solid particles that form a mechanical support or a type of framework. For example, the bed may result from the application of layers. It is also called a bulk material. An essential characteristic of a bed is the porous structure. The pores are formed and limited by the framework-forming phase. The embodiment with a bed proves advantageous with regard to the mechanical strength of a wall of a transport device and/or homogenizing device and/or conditioning device. A bed advantageously possesses a storage effect for the fluid. The bed can also have a shell.

Another possibility for forming a defined atmosphere 15a is illustrated in FIG. 17. Wall 8 from FIG. 13 or a corresponding device is encapsulated with an additionally arranged fluid curtain, preferably a gas curtain 16. The defined atmosphere 15a is produced by means of fluid curtain 16 only locally or in a limited space, i.e., between melt-facing side 9a of diffusion barrier layer 9 and the outlet opening of a tubing system 17. Tubing system 17 is arranged, for instance, in a coil shape or as a coil system around the outside wall 8, the fluid being conducted through tubing system 17. In the direction of side 9b of diffusion barrier layer 9 facing away from the melt, or in the direction of wall 8, corresponding openings from which the fluid can exit are provided. In one embodiment, the coil system additionally forms the coil system for inductive heating of melt 1. FIG. 18 shows another embodiment of fluid curtain 16, wherein the fluid is produced by means of individual nozzles 18.

In order to be able to generate an appropriately defined atmosphere 15a, the devices from FIG. 2 can also be furnished completely with a schematically represented encapsulation 15, as shown for the sake of example in FIG. 19.

As already stated, a wall 8 or a diffusion barrier layer 9 in the sense of the application comprises not only the jacket or wall 8 of the component used in the production of glass or in handling glass melt 1, but also the entire body of which the corresponding component is composed or formed. In other words, not only one area or the jacket of the component, but also the core of the component, have the same material.

In that regard, FIG. 20 shows for the sake of example the stirring device, more precisely the stirrer 7 from FIG. 2, in an enlarged representation. In the present case, the entire component, here the entire stirring device 7, consists of an iridium-containing section 7a. In other words, stirring device 7 is produced from iridium or an iridium alloy with the above-mentioned properties.

FIG. 21 shows the stirring device 7 corresponding to FIG. 20, but constructed in this case is a two-layer system. Stirring device 7 has a jacket 7b, which has contact with the melt and thus represents a melt contact layer 9, and a core 7c, which has no contact surface with the melt. Accordingly, only requirements with respect to thermal and mechanical stability are placed on core 7c. The core thus represents a carrier layer 10 in the sense of the application. Core 7b is encapsulated by means of an iridium-containing diffusion barrier layer 9 comprising iridium or an iridium alloy that is deposited on its surface. This imparts the necessary chemical stability to stirring device 7.

FIGS. 22a-22d schematically show the mechanism of the oxygen diffusion inhibition of iridium-comprising components. It is shown that the thermal decomposition of the water 30 contained in the glass melt increases with increasing temperature from FIG. 22a to 22d. In FIG. 22d, in which the temperature is the highest, a part of the water 30 has dissociated into hydrogen 32 and oxygen 31. Due to the high density of iridium-comprising wall 35, a diffusion of hydrogen from interior 33 into exterior 34 through an iridium comprising wall 35 is prevented.

The diffusion of hydrogen through a metal component, a platinum wall for instance, is represented in FIGS. 23a-23d. FIGS. 23a-23d show that the thermal decomposition of the water 30 contained in the glass melt increases with increasing temperature from FIG. 23a to 23d. As is visible from FIG. 23b, a diffusion of hydrogen through platinum wall 35 begins immediately after the beginning of thermal cleaving of water 30 into oxygen 31 and hydrogen 32. Since platinum is permeable to hydrogen 32, a concentration equilibrium comes about on both sides of wall 35. The excessive oxygen 31 remaining in interior space 33 causes the creation of bubbles, particularly in the wall area, due to an increased oxygen partial pressure during the cooling of melt 1.

It is evident to the person skilled in the art that the above-described embodiments are to be understood as examples. The invention is not limited to them, but can be varied in a number of ways without departing from the spirit of the invention. The characteristics shown separately can also be combined with one another.

### LIST OF REFERENCE NUMBERS

1 Melt or glass melt
1a Melt surface
1b Melt flow
2 Melting crucible
3 First channel
4 Refining tub
5 Second channel
6 Homogenizing device
7 Stirrer
7a Iridium-containing section
7b Jacket
7c Core
8 Wall
8a Melt contact surface
9 Diffusion barrier layer
9a Melt-facing side
9b Side facing away from the melt
9c Iridium-containing (wall) section
9d Low-iridium (wall) section
9e Iridium-free (wall) section
10 Carrier layer
11 Protective layer
12 Conditioning device
13 Coil system
14 Space between melt surface 1a and wall 8
15 Encapsulation
15a Defined atmosphere
16 Fluid curtain
17 Tubing system
18 Nozzle
19 Porous material
30 Water molecule
31 Oxygen atom
32 Hydrogen atom
33 Interior
34 Exterior
35 Iridium-comprising wall
36 Platinum wall
A1 Section of wall 8 from FIG. 2

1-59. (canceled)

60. Method for transporting, homogenizing and/or conditioning a glass melt (1), characterized by:
adjusting a dwell time of the glass melt (1) in a transport device and/or homogenizing device (6) and/or conditioning device (12) at least by means of the flow velocity of the glass melt (1) such that, by means of at least one section of a wall (8) of the transport device and/or homogenization device (6) and/or conditioning device (12) that is provided with an iridium-comprising diffusion barrier layer (9), the dwell time of the glass melt (1) at a temperature of the glass melt (1) of 700° C. to 1700° C. in the transport device and/or homogenization device (6) and/or conditioning device (12) is such that the diffusion of hydrogen through the wall (8) is at least reduced by the diffusion barrier layer and the oxygen partial pressure in the glass melt (1) has a value less than 1 bar.

61. Method according to claim 60, characterized in that the diffusion barrier layer (9) is provided with an iridium content of 10-100 wt %.

62. Method according to claim 60, characterized in that the diffusion barrier layer (9) is provided with a content of iridium that decreases starting from the melt-facing side (9a) of the diffusion barrier layer (9) in the direction of the side (9b) of the diffusion barrier layer (9) facing away from the melt.

63. Method according to claim 60, characterized in that the diffusion barrier layer (9) is provided with a content of iridium that increases starting from the melt-facing side (9a) of the diffusion barrier layer (9) in the direction of the side (9b) of the diffusion barrier layer (9) facing away from the melt.

64. Method according to claim 60, characterized in that the wall (8) of the transport device and/or the homogenizing device (6) and/or the conditioning device (12) is formed by the diffusion barrier layer (9).

65. Method according to claim 60, characterized in that the wall (8) is formed by an arrangement of individual layers.

66. Method according to claim 65, characterized in that the wall (8) is provided with at least one carrier layer (10).

67. Method according to claim 66, characterized in that the carrier layer (10) is formed by the diffusion barrier layer (9).

68. Method according to claim 66, characterized in that the carrier layer (10) is formed by at least one refractory material.

69. Method according to claim 66, characterized in that the diffusion barrier layer (9) is provided on the carrier layer (10).

70. Method according to claim 66, characterized in that the wall (8) is provided with at least one protective layer (11).

71. Method according to claim 70, characterized in that the protective layer (11) is formed by at least one refractory material.

72. Method according to claim 60, characterized in that a defined atmosphere (15a) is provided at least in the area of the diffusion barrier layer (9).

73. Method according to claim 72, characterized in that the defined atmosphere (15a) is produced by means of a fluid.

74. Method according to claim 73, characterized in that the defined atmosphere (15a) is provided by means of a fluid curtain.

75. Method according to claim 73, characterized in that the fluid is conducted in a tubing system (17) and/or a porous material (19).

76. Device for producing a glass comprising:
a melt crucible (2) for melting a batch;
a device (4) for refining a glass melt (1); and
a device for transporting (5) and/or homogenizing (6) and/or conditioning (12), characterized in that at least one section of a wall (8) of the transport device, homogenization device (6) and/or conditioning device (12) has an iridium-comprising diffusion barrier layer that reduces the diffusion of hydrogen, wherein the dwell time of the glass melt (1) in the device for transporting and/or homogenizing and/or conditioning is adjusted such that the diffusion of hydrogen through wall (8) is at least reduced, the oxygen partial pressure in the glass melt (1) has a value less than 1 bar, and the new formation of bubbles after refining is reduced.

77. Device according to claim 76, characterized in that the diffusion barrier layer (9) has an iridium content of 10-100 wt %.

78. Device according to claims 76, characterized in that the diffusion barrier layer (9) has a content of iridium that decreases starting from the melt-facing side (9a) of the diffusion barrier layer (9) in the direction of the side (9b) of the diffusion barrier layer (9) facing away from the melt.

79. Device according to claims 76, characterized in that the diffusion barrier layer (9) is provided with a content of iridium that increases starting from the melt-facing side (9a) of the diffusion barrier layer (9) in the direction of the side (9b) of the diffusion barrier layer (9) facing away from the melt.

80. Device according to claim 76, characterized in that the wall (8) is formed by the diffusion barrier layer (9).

81. Device according to claim 76, characterized in that the wall (8) is formed by an arrangement of individual layers.

82. Device according to claim 81, characterized in that the wall (8) has at least one carrier layer (10).

83. Device according to claim 82, characterized in that the carrier layer (10) comprises the diffusion barrier layer (9).

84. Device according to claim 82, characterized in that the carrier layer (10) has at least one refractory material.

85. Device according to claim 83, characterized in that the diffusion barrier layer (9) is arranged on the carrier layer (10).

86. Device according to claim 81, characterized in that the wall (8) has at least one protective layer (11).

87. Device according to claim 86, characterized in that the protective layer (11) is formed by at least one refractory material.

88. Device according to claim 76, characterized in that the diffusion barrier layer (9) is arranged in a defined atmosphere (15a).

89. Device according to claim 88, characterized in that the defined atmosphere (15a) comprises a fluid.

90. Device according to claim 89, characterized in that the defined atmosphere (15a) comprises a fluid curtain.

91. Device according to claim 89, characterized in that the fluid is conducted in a tubing system (17) and/or a porous material (19).

92. A method for adjusting a dwell time of a glass melt (1) in a transport device and/or homogenizing device (6) and/or conditioning device (12), comprising:
utilizing iridium as at least one component of a diffusion barrier layer (9) of at least one section of a wall (8) in the transport device and/or homogenizing device (6) and/or conditioning device (12), such that the oxygen partial pressure in the glass melt has a value less than 1 bar.
